(19) United States
(12) Patent Application Publication
(10) Pub. No.: US 2011/0221262 A1
(43) Pub. Date: Sep. 15, 2011

(54) Runflat System with Interconnected Sectors

(76) Inventors: Larry W. Stuck, Amherst, NY (US); Charles J. Tabone, North Tonawanda, NY (US); Kelly M. McCorry, Cheektowaga, NY (US)

(21) Appl. No.: 13/054,488

(22) PCT Filed: Jul. 24, 2009
(86) PCT No.: PCT/US2009/004311

§ 371 Date: May 26, 2011

Related U.S. Application Data
(60) Provisional application No. 61/135,978, filed on Jul. 24, 2008.

(51) Int. Cl. B60C 17/04

(52) U.S. Cl. 301/9.1

(57) ABSTRACT

This improved runflat system is formed from a plurality of arcuate sectors, each of said sectors being linked to at least one other sector such that the sectors form a substantially continuous ring around the wheel. The sectors are preferably provided with and joined by integral overlapping and interlocking connector parts positioned at the ends of each sector. No tools or other extraneous hardware is required to join the sectors together and the structure of the connector parts in some embodiments allows rotation around an interconnection rotational axis, such that each sector can be rotated around said interconnection rotation axis with respect to an adjacent sector. In addition, in various optional embodiments, the invention includes connection means that allow rotation between sectors, latching means for holding sectors together, and structure(s) that help to eliminate frictional heating (and concomitant system failure) between the runflat sectors and the tire by making the runflat sectors freely rotating with respect to the tire and/or by providing compensators between sectors and tire that likewise serve to reduce friction and heating.

### CROSS-REFERENCE TO RELATED APPLICATIONS

This application claims an invention which was disclosed in a U.S. provisional patent application filed Jul. 24, 2008, Ser. No. 61/135,978, entitled “Runflat System with Rotating Interconnected Sectors”. Priority benefit of the said United States provisional application is hereby claimed, and the aforementioned application is hereby incorporated herein by reference.

### BACKGROUND AND SUMMARY

This invention pertains to the integration of a runflat system including a runflat ring comprised of interconnected sectors or segments into a wheel. More particularly, the system of the invention includes an easy to assemble open-bottom connection system incorporated directly into a runflat device that couples multiple sectors together to form a runflat ring. The quick assembly process inherent in the inventive concept does not require fastening hardware and supersedes the historic need for special tools or equipment to install runflats. In addition, in various optional embodiments, the invention includes connection means that allow rotation between sectors, latching means for holding sectors together, and structure(s) that help to eliminate frictional heating (and concomitant system failure) between the runflat ring/runflat sectors and the tire by making the runflat ring/sectors freely rotating with respect to the tire and/or by providing compensators between runflat ring/++sectors and tire that likewise serve to reduce friction and heating.

Prior art runflat designs have typically been produced from natural rubber, plastic or metal and have numerous disadvantages. Natural rubber runflat designs and runflat rings generally take the form of a continuous loop that needs to be compressed with a large press to insert into a tire. Removal is also difficult, as the runflat system must be pulled from the tire cavity after being manually collapsed with a large strap.

However, the available alternative—prior art plastic and metal runflats—even though produced in sectors rather than as a continuous loop, have their own problems. To begin with, current plastic and metal runflats require installation of hardware, often unique to the runflat design, to secure the unit on the wheel. In addition, neither natural rubber runflats (which are inherently single-piece designs) nor assembled plastic and metal runflats (which form rigid structures after assembly) allow rotation between sectors. Further, assembly of current plastic and metal designs require hardware and components that are generally only available through the original equipment manufacturer, that can be misplaced within the tire cavity, and that can thereby cause premature system failure. This hardware also requires tools that will not generally be readily available to soldiers, particularly soldiers in the field (who will be those most in need of making quick and effective repairs). Finally, when tightened, such hardware can strain the components of a plastic runflat system and create a plastic creep situation that causes the hardware to loosen as well as fatigue with time.

The improved runflat system described herein teaches a system comprising a plurality of arcuate sectors, each of said sectors being linked to at least one other sector such that said plurality of sectors form a substantially continuous ring around the wheel. These sectors are provided with and joined by integral overlapping and interlocking connector parts positioned at the ends of each sector. The structure of the connector parts in some embodiments allows rotation around an interconnection rotational axis, such that each sector can be bi-directionally rotated (i.e., clockwise and counterclockwise) around said interconnection rotation axis with respect to an adjacent sector.

The foregoing features and others of the inventive concept, as more fully described below, provide numerous advantages over the systems of prior art. First, the invention maintains runflat load integrity by restraining forces and absorbing shocks in the axial, radial and circumferential directions. Second, the invention can increase the ability of the runflat to absorb energy caused by wheel impact and will reduce the shock transmitted to the vehicle due to the foregoing. Third, the energy absorption characteristics of the invention can be modified by varying the support provided via the spacers of the invention by selecting different types of elastomeric, plastic, metallic or other spacer materials therefor. Fourth, the invention is quick and easy to assemble and requires neither hardware nor special tools. Fifth, its optional friction reducing features serve to eliminate a major cause of runflat/tire failure. Finally, its durability and effectiveness in its role, as well as the simplicity of construction and installation created by its innovative design features, makes it a system that is easy to use while remaining extremely sturdy and robust, making it ideal for the types of military uses and situations contemplated for the invention.

### BRIEF DESCRIPTION OF THE DRAWINGS

FIG. 1 provides a perspective view of a first embodiment of the instant invention assembled on a wheel.

FIG. 2 provides a perspective partial cross-sectional view of a sector of the first embodiment of the instant invention assembled on a wheel.

FIG. 3 provides a cross-sectional schematic view of a sector of the first embodiment of the instant invention assembled on a wheel.

FIG. 4A provides a perspective view of an end of a sector of the first embodiment of the instant invention, providing a more detailed view of the features characterizing the male connector portion and arcuate support shoulder that form integral parts of the sector at that end.

FIG. 4B provides a perspective view of an opposite end of a sector of the first embodiment of the instant invention, providing a more detailed view of the features characterizing the female connector portion and arcuate support arch that form integral parts of the sector at said opposite end.

FIG. 5A provides a schematic cross-sectional view illustrating the male connector portion of a sector positioned within the female connector portion of another sector the first embodiment of the instant invention.

FIG. 5B provides a schematic cross-sectional view illustrating the male connector portion of a sector positioned within the female connector portion of another sector of the first embodiment of the instant invention where the female connector portion and its sector have been rotated by a minimum of approximately ten degrees with respect to the male connector portion and its sector.

FIG. 6 provides a schematic cross-sectional view illustrating the arcuate support shoulder of a sector positioned on the arcuate support arch of another sector of the first embodiment of the instant invention.

FIG. 7 provides a perspective view of an end of a sector of the first embodiment of the instant invention, providing a more detailed view of features characterizing an optional sector latching system that can be used to facilitate connection and rotation of adjacent sectors.

FIG. 8 provides a schematic cross-sectional view of the first embodiment of the invention illustrating the male connector portion of a sector positioned within the female connector portion of another sector and the latching system that can be used to facilitate connection and rotation of these adjacent sectors.

FIG. 9 provides a schematic cross-sectional view of the first embodiment of the invention illustrating the male connector portion of a sector and of portions of the latching system included therein.

FIG. 10 provides a schematic cross-sectional view of the first embodiment of the invention illustrating the female connector portion of a sector and of portions of the latching system included therein.

FIG. 11 provides a cross-sectional schematic view of a sector of a second embodiment of the instant invention assembled on a wheel

FIG. 12A provides a perspective view of an end of a sector of the second embodiment of the instant invention, providing a more detailed view of the features characterizing the male connector portion that forms an integral parts of the sector at that end.

FIG. 12B provides a perspective view of an end of a sector of the second embodiment of the instant invention, providing a more detailed view of the features characterizing the female connector portion that forms an integral parts of the sector at that end.

FIG. 12C provides a perspective view of an end of a sector of the second embodiment of the instant invention featuring a modified male connector portion formed as an integral part of the sector at that end.

FIG. 12D provides a perspective view of an end of a sector of the second embodiment of the instant invention featuring a modified female connector portion adapted for connection to the modified male connector of FIG. 12C, which female connector portion is likewise formed as an integral part of the sector at that end.

FIG. 12E provides a perspective view of the second embodiment of the instant invention assembled on a wheel.

FIG. 13A provides a schematic cross-sectional view of the second embodiment of the invention illustrating the male connector portion of a sector positioned within the female connector portion of another sector.

FIG. 13B provides a schematic cross-sectional view of the second embodiment of the invention illustrating the modified male connector portion illustrated in FIG. 12C positioned within the modified female connector portion illustrated in FIG. 12D.

FIG. 14 provides a schematic perspective view of the circular runner which is used with and forms a portion of the second embodiment of the invention.

FIG. 15A provides a first schematic perspective view of optional circumferential compensators that can be provided with and assembled to the outer periphery of a sector to reduce friction, increase functionality, and otherwise improve function.

FIG. 15B provides a second schematic perspective view of the optional circumferential compensators illustrated in FIG. 15A.

FIG. 15C provides a side schematic view of the optional circumferential compensators illustrated in FIG. 15A.

### DESCRIPTION

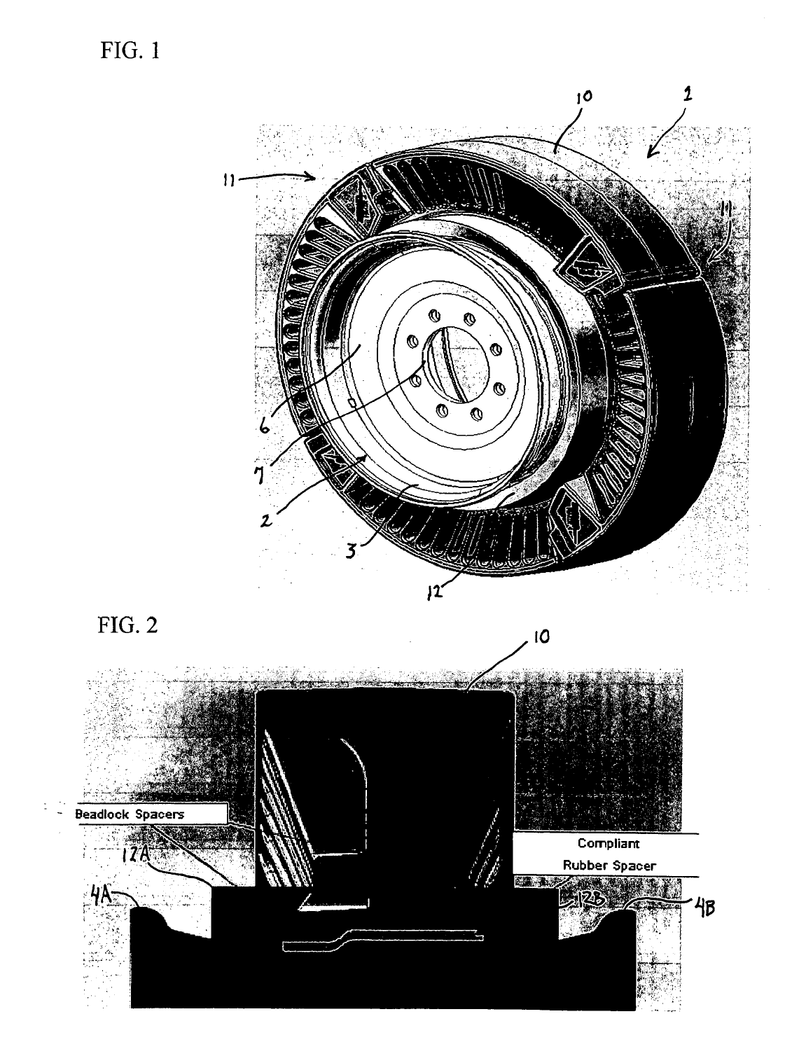

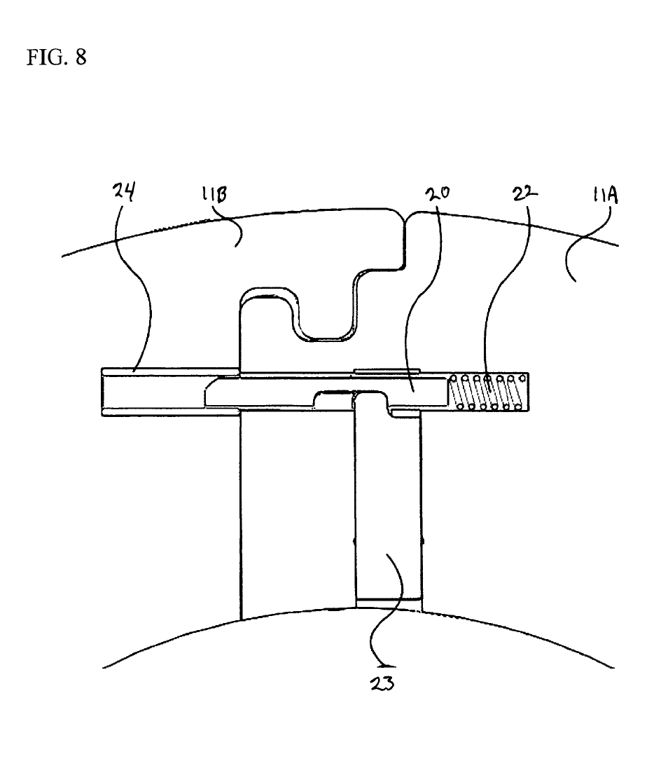

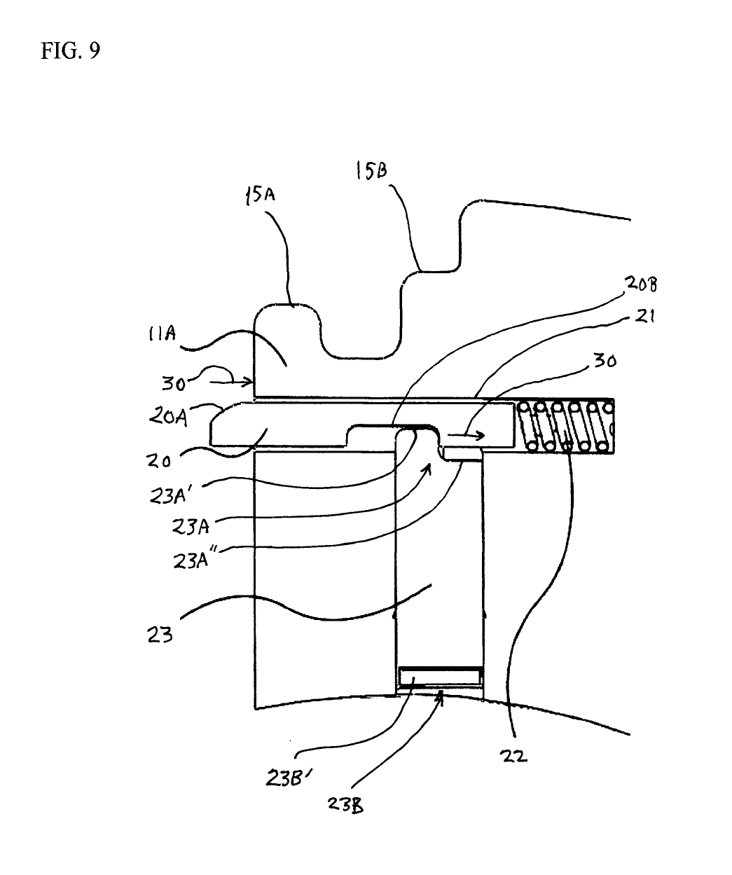

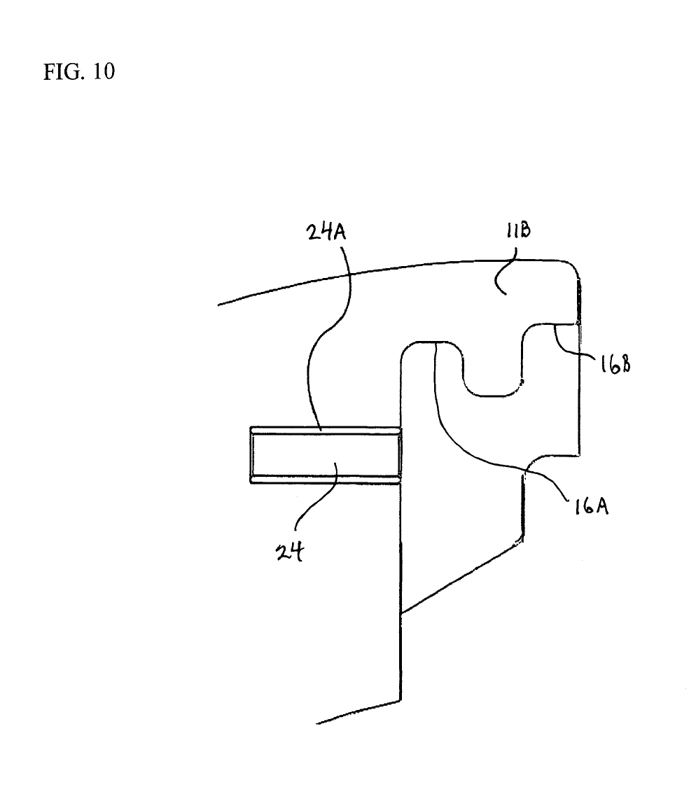

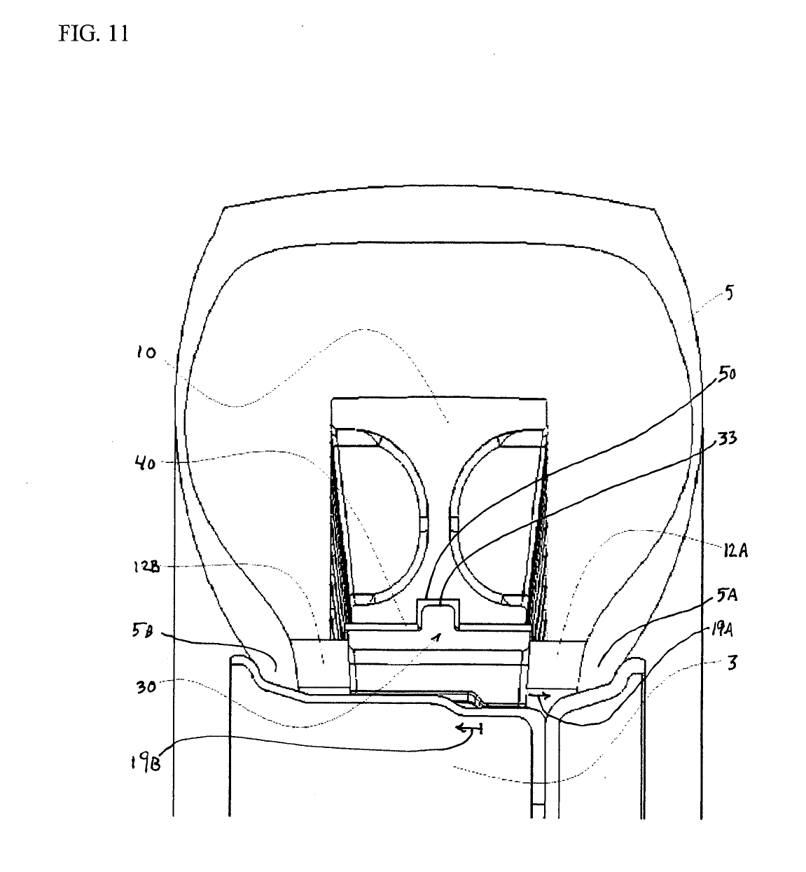

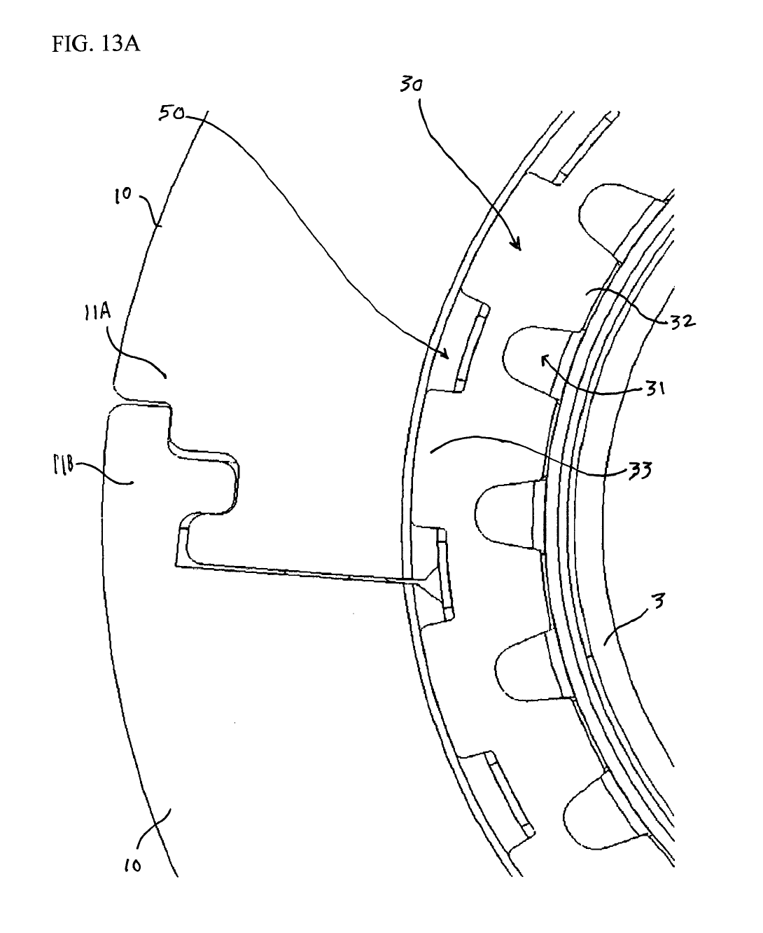

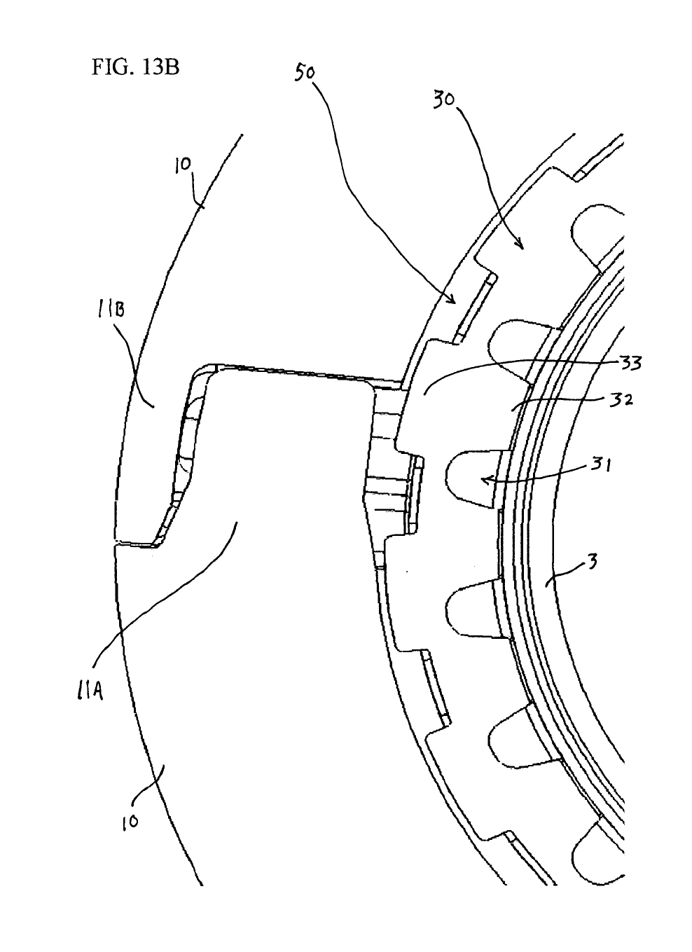

A first and more basic mode of implementing our invention is illustrated in FIGS. 1-10. A second and more preferred mode is illustrated in FIGS. 11-15C. However, both the more basic mode and the preferred mode share many features in common. Thus, both modes of practicing the invention can best be understood, and are covered below, by initially reviewing and analyzing the mode described in FIGS. 1-10, while simultaneously referencing features the more basic mode shares in common with the preferred mode (which is illustrated in FIGS. 11-15C). After reviewing the first mode of the invention and similar features found in the preferred mode, the more distinctive elements of the preferred mode of the invention will be described and discussed. Included also in the foregoing discussions will be descriptions of three optional features or variations that may be incorporated into the invention: latching elements between interconnected sectors, a variation on the connectors used between interconnected sectors, and apparatus and/or structures for decreasing friction between runflat sectors and tire.

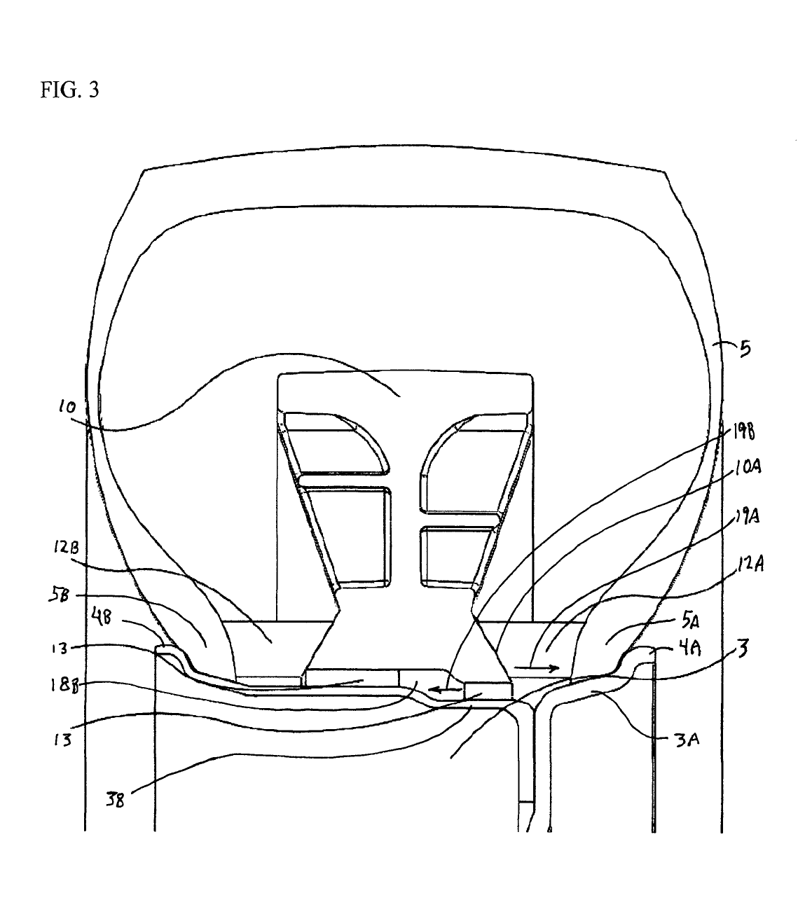

FIGS. 1 and 2 provide an initial overview of the first and more basic mode, showing a runflat system of the instant invention (denoted generally by arrow 1) assembled on a 2-piece wheel (denoted generally by arrow 2). Wheel 2 is characterized by a circular wheel rim 3 formed from an outer section 3A and an inner section 3B, and has formed coaxially on opposite ends thereof outwardly flaring circumferential flange sections 4A, 4B disposed to be engaged by the beads 5A, 5B of a tubeless tire 5 mounted on the rim 3, as best seen in FIG. 3. The wheel rim 3 has intermediate said opposite ends thereof a transverse wall section (or central disc) 6 extending transversely of the axis of said rim, and having therethrough a central opening 7 disposed coaxially of said axis.

The runflat system of both modes of the invention is formed from a plurality of arcuate sectors 10, each of said sectors 10 being linked to at least one other sector 10 such that said plurality of sectors 10 forms a substantially continuous ring (as illustrated in FIG. 1) around said wheel 2 within said tire 5. And, all modes of the invention, each of said sectors 10 is advantageously provided with integral overlapping and interlocking connector parts 11 at their ends by which they can be linked together. In keeping with the teachings and purposes of the invention, each of said integral connector parts 11 is best formed as a molded portion of its sector 10, such that each sector 10 and its respective connector parts 11 form a single one-piece molded part.

In addition, beadlock spacers 12A, 12B are also provided and used in both modes of the invention described herein. These are preferably formed as continuous bands so as to form rings around said wheel rim 3 intermediate the beads 5A, 5B of tire 5 and the sides of sectors 10 when mounted in operating position. The beadlock spacers 12A, 12B are important to the system for several reasons. First, they inhibit lateral movement of the runflat system with its plurality of sectors 10 (i.e., movement parallel to said rim axis) in both embodiments. Second, they assist in centering the runflat system of the invention with its sectors 10 in optimum operating position on wheel rim 3 between beads 5A, 5B within tire 5. Third, they serve to assist in the runflat operations of the system by locking beadlocks 5A, 5B in position against rim flanges 4A, 4B. Fourth, they interact with surfaces 10A of sectors 10 of the embodiment illustrated in FIGS. 1-10 so as to assist in holding the sectors 10 firmly against the rim 3. (This overlap also produces advantages from a shock absorption standpoint as will be discussed more fully below).

The function of the beadlock spacers 12A, 12B is advantageously supplemented by a stationary rim abutting element or elements that is/are adapted to abut and remain stationary with respect to the rim. In the embodiment illustrated in FIGS. 1-10 the role of stationary rim abutting element(s) is played by bottom spacer(s) 13 formed as a continuous band or bands so as to, once again, form a ring around wheel rim 3. In the basic embodiment, the bottom spacer(s) 13 is/are positioned between said wheel rim 3 and said plurality of sectors 10, and not only serve to some degree as a shock absorber, but more importantly, serve to inhibit excessive sliding movement of said plurality of sectors 10 around said wheel rim 3 and hold said plurality of sectors 10 in proper spaced relationship to said rim 3. (As will be seen in discussions of the preferred embodiment, infra, a separate part (runner 30) serves as a stationary rim abutting element, replacing both the bottom spacers 13 and the rim adjacent portion of sectors 10 illustrated in FIGS. 1-10).

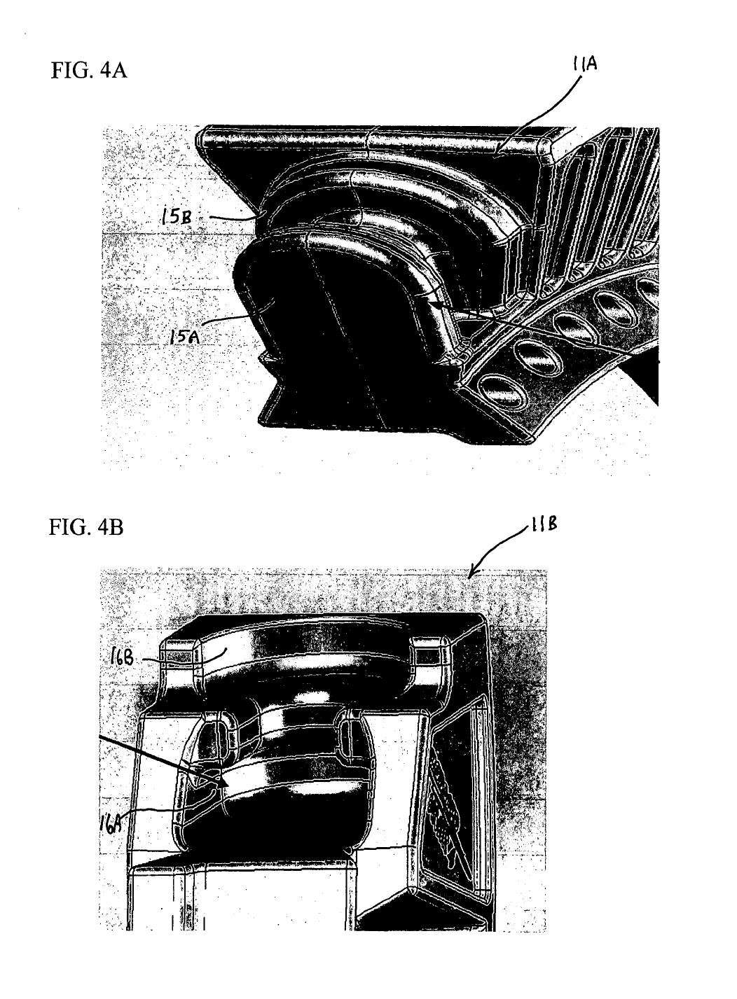

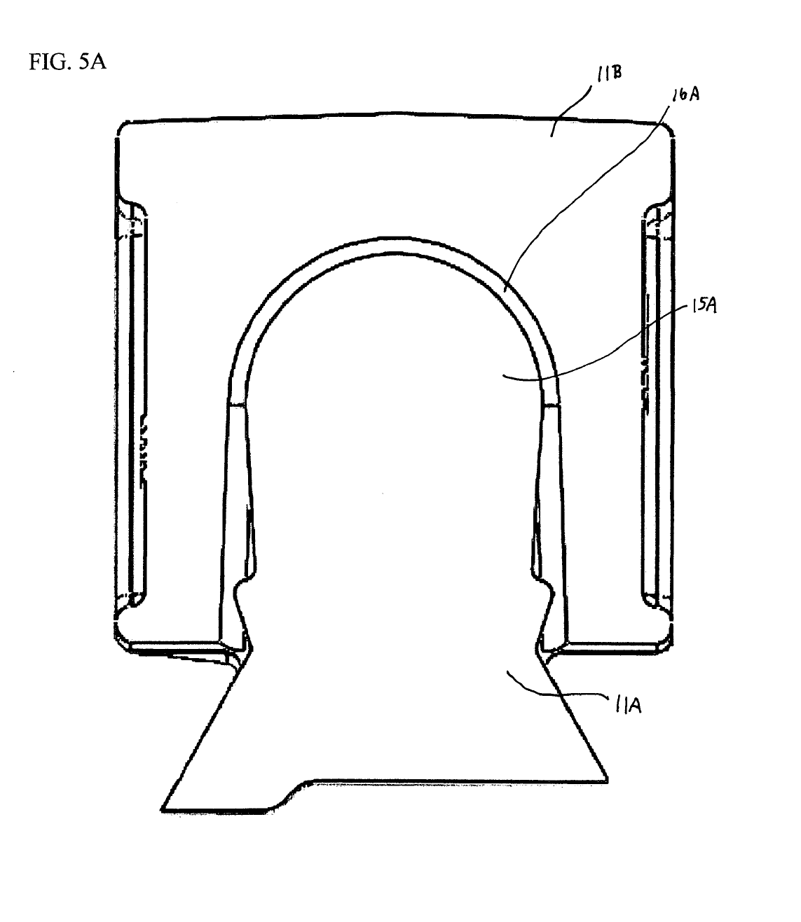

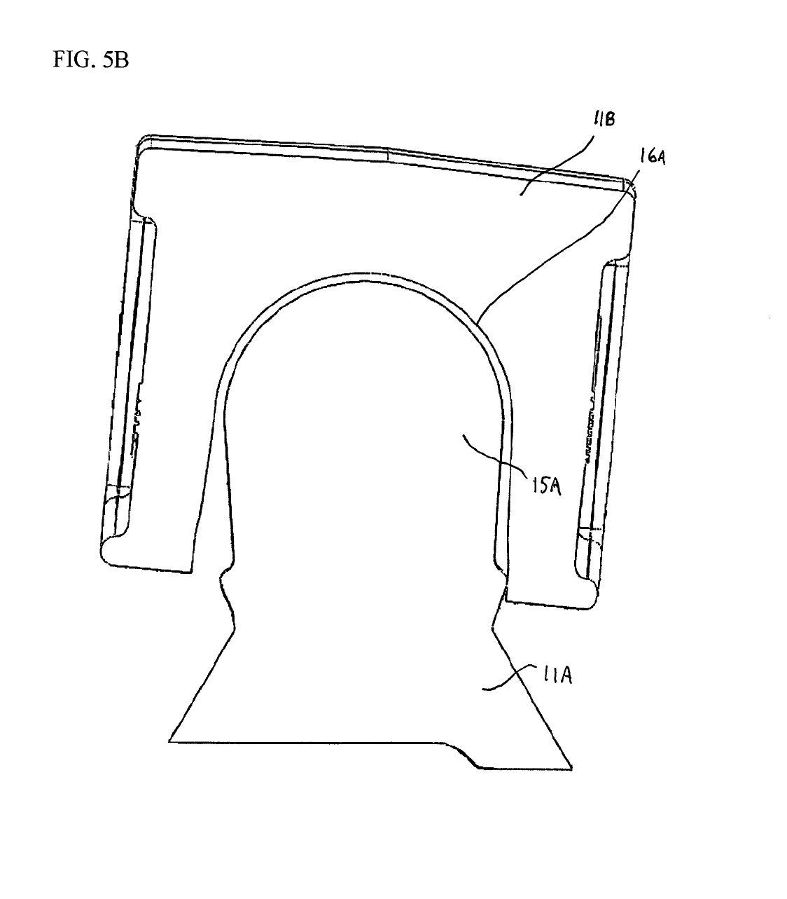

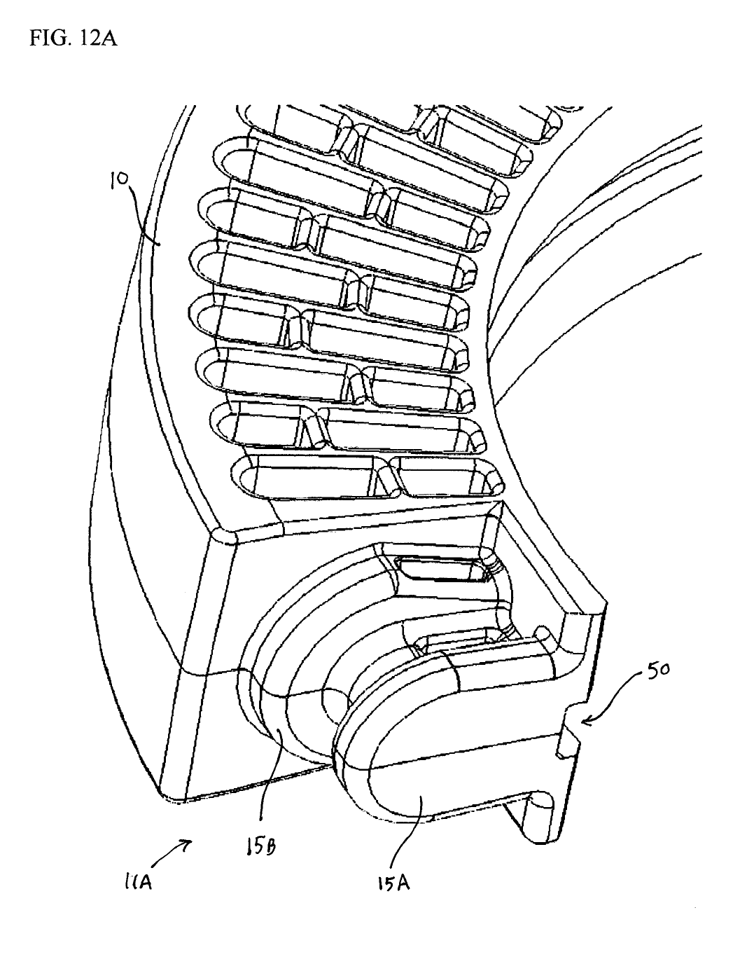

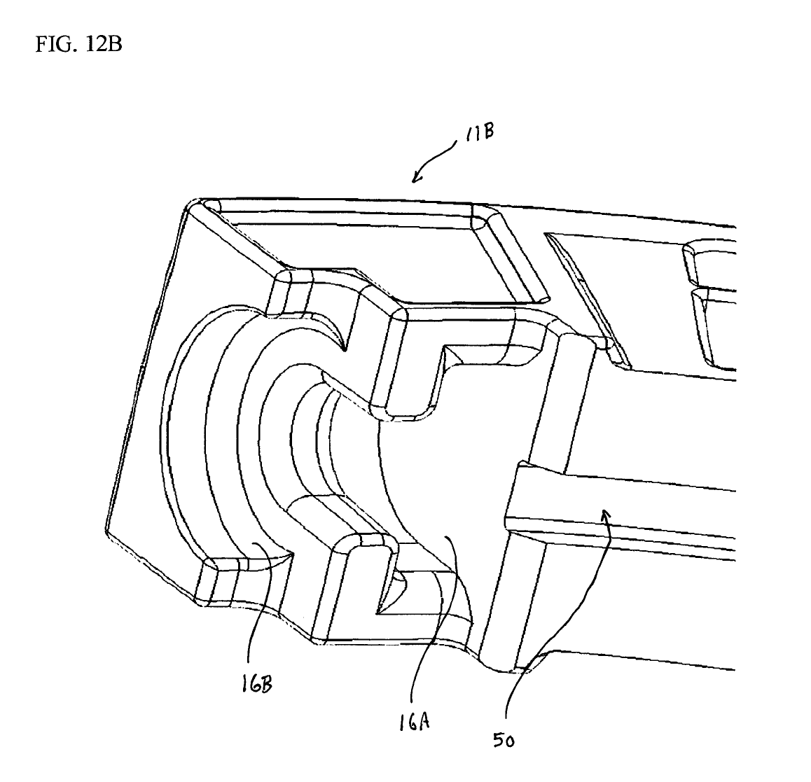

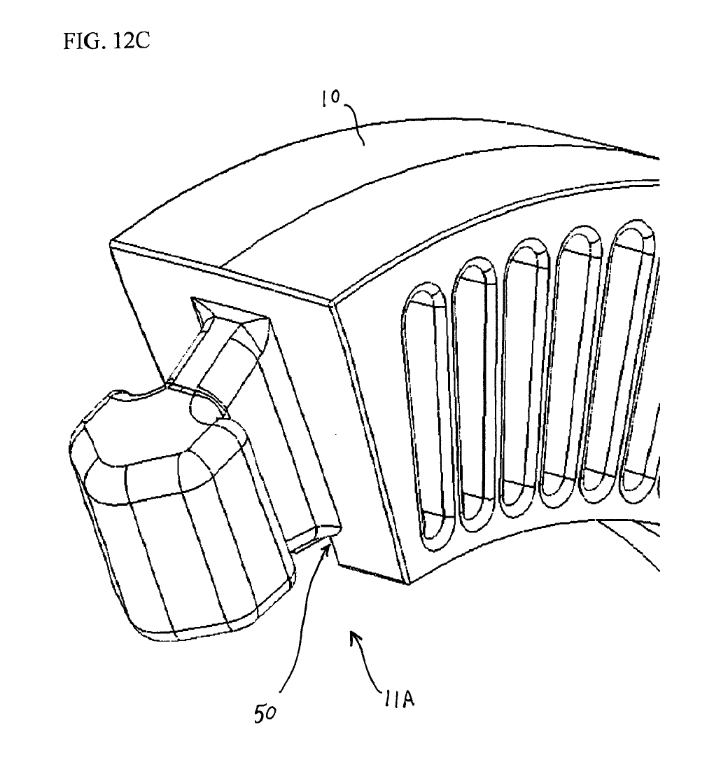

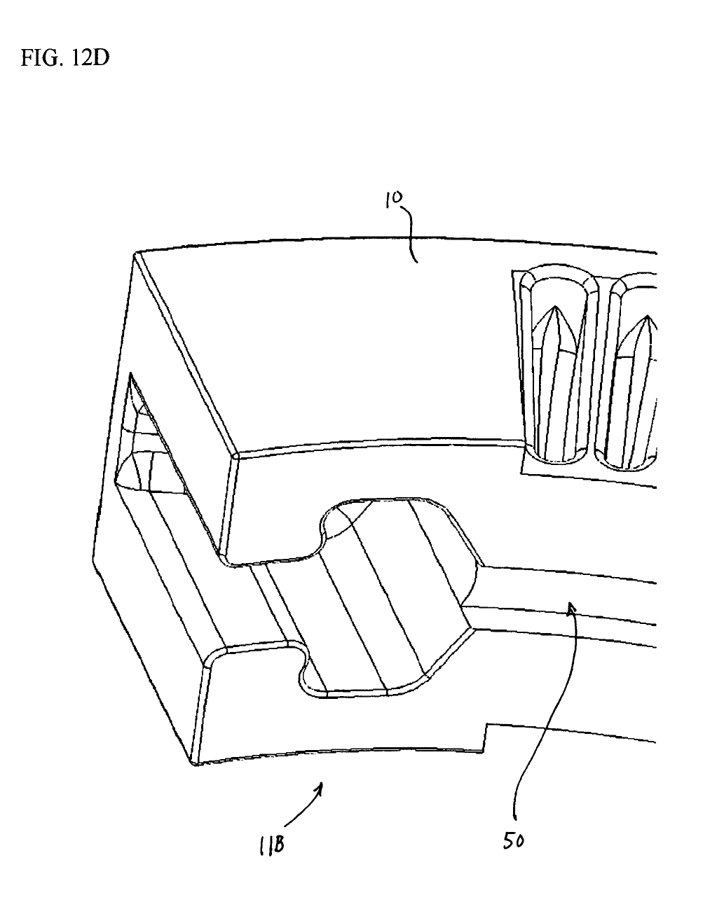

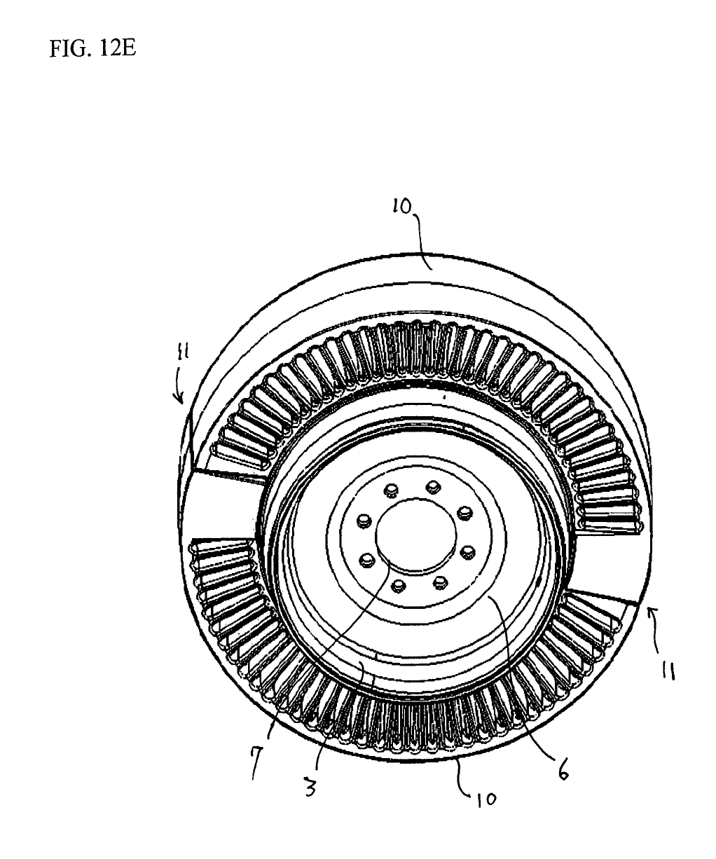

A more detailed appreciation for the structure and innovations inherent in the integral overlapping and interlocking connector parts 11 of both the basic and the preferred embodiments illustrated can be obtained from review of FIGS. 4A, 4B, 12A, 12B, 12C and 12D. FIGS. 4A, 12A and 12C provide perspective views of ends of a sector 10 and of the connector parts 11 that form an integral part thereof. In these figures, the connector part 11 is a lower connector part 11A featuring a male connector portion 15A. In the embodiments illustrated in FIGS. 4A and 12A an arcuate support shoulder 15B is also formed as an integral part of the sector 10 at that end. Likewise, FIGS. 4B, 12B and 12D provide perspective views of opposite ends of a sector 10 and of the upper connector part 11B that forms an integral part thereof. In this case, the connector part 11 features a female connector portion 16A. And, likewise, the embodiments illustrated in FIGS. 4B and 12B include an arcuate support arch 16B that is, once again, formed as an integral part of the sector 10 at that end.

As will be obvious from the aforesaid drawing figures and discussions, two complementary connector parts 11 of adjacent sectors 10 (lower connector part 11A and upper connector part 11B) form an overlapping and interlocking connection when the upper connector part 11B is placed over the lower connector part 11A such that male connector portion 15A is inserted into female connector portion 16A. In this position, adjacent sectors are prevented from pulling away from each other via the connection between male/female portions 15A, 16A. And, in the embodiments illustrated in FIGS. 4A, 4B, 12A, and 12B, the junction between arcuate support arch 16B and arcuate support shoulder 16A forms a bearing surface that not only serves to transfer radial forces and impacts through the connector parts 11 to wheel rim 3, it serves to allow (in conjunction with the design of male/female portions 15A, 16A) rotation of adjacent sectors 10 with respect to each other.

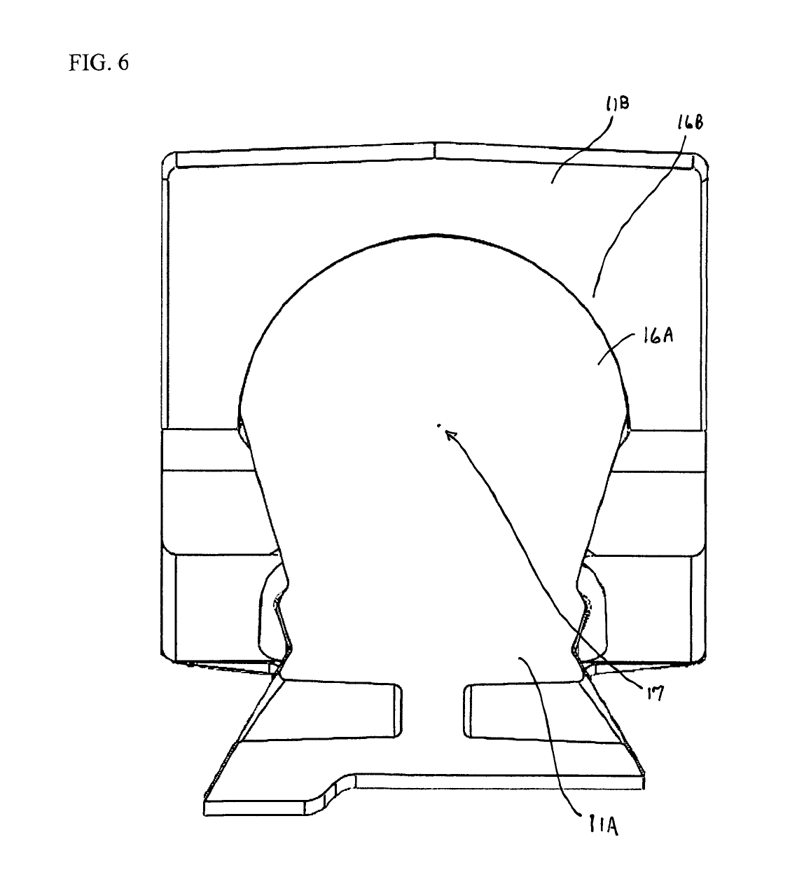

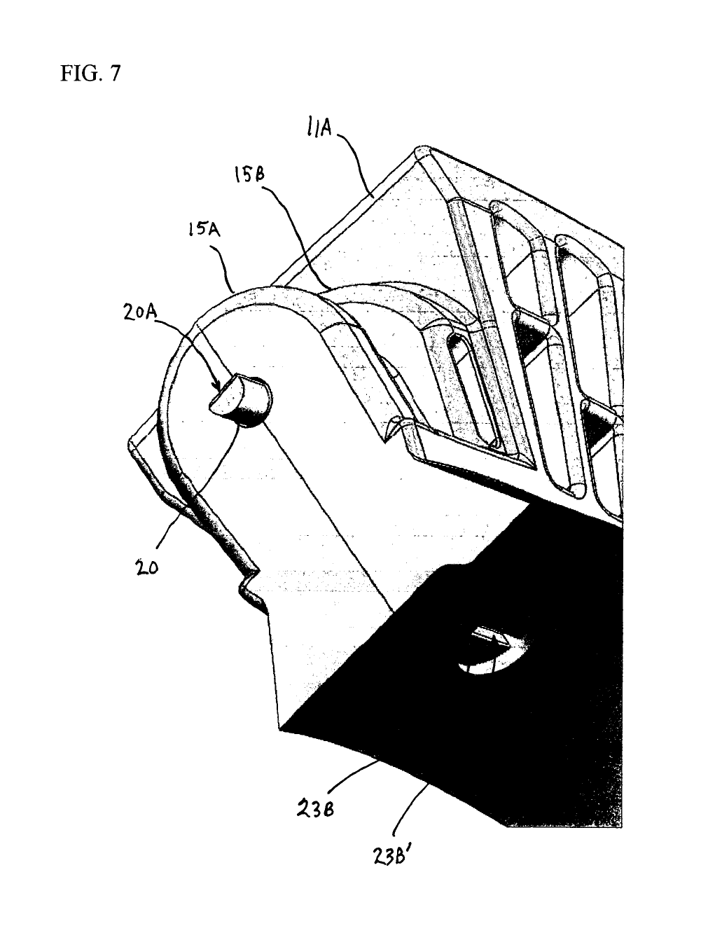

A better understanding of the “rotation” feature described above can be obtained by review of FIGS. 5A, 5B and 6. FIGS. 5A and 5B provide schematic cross-sectional views illustrating the male connector portion 15A of a sector 10 positioned within the female connector portion 16A of an adjacent connected sector 10. As will be noted, space remains around the sides of male connector portion 15A, such that the female connector portion 16A and its sector 10 can be rotated by a minimum of approximately ten degrees in either direction with respect to the male connector portion 15A and its sector 10 (as illustrated in FIG. 5B). This is made possible not only by the space allowances described, but by the nature of the arcuate sliding connection between the arcuate support arch 16B of a sector when it is positioned on the of arcuate support shoulder 15B of another sector, as best seen with reference to FIG. 6. As the latter figure illustrates, the arcs defining said arch 16B and shoulder 15B are both centered on a point 17, which can also be considered to define and represent an interconnection rotational axis 17 around which arcuate support arch 16A along with upper connector part 11B (and its integrally connected sector 10) can rotate.

The preferred (and extremely simple) method of assembly of the embodiment of the invention illustrated in FIGS. 1-10 can easily be understood by reference, as needed, to the drawing figures. First, referring generally to FIGS. 1 and 3, the sectors 10 are interconnected within the tire 5 by hand with no tools being necessary or even helpful for this purpose. Second, the bottom spacer band 13 and the inner beadlocking spacer 12B are pre-positioned appropriately around the inner section 3B of rim 3. Third, the inner section 3B is then inserted through the open center of assembled sectors 10 (and tire 5), and inner bead 5B is positioned intermediate sectors 10 and inner flange 4B. Fourth, outer beadlocking spacer 12A is prepositioned intermediate outer tire bead 5A and linked and assembled sectors 10. Fifth, outer section 3A is assembled to inner section 3B of rim 3, securing the various components mentioned in operative position.

After assembly, the foregoing parts cooperate synergistically to absorb radial, circumferential, and axial shocks in the absence of inflation in tire 5. From a radial standpoint, all shocks perpendicular to the central axis of wheel 2 (e.g., standard up/down shocks) are absorbed and buffered by the sectors 10 (including their overlapping sections 11A, 11B) and bottom spacer 13, and transferred by them to wheel rim 3 and ultimately in most cases to the shock absorbers of the vehicle. From a circumferential standpoint (i.e., for shocks conveyed along the loop formed by the assembled sectors 10), the connection between adjacent sectors 10 transmits such shocks to the assembly as a whole, which can dissipate such energy (even subject to the fact that bottom spacer 13 severely inhibits rotational movement with respect to and between the assembled sectors 10 and rim 3) via limited movement around and with respect to rim 3. From an axial standpoint, as more fully discussed in the following paragraph, the situation is more complex.

For an axial shock (i.e., a shock parallel to the central axis of wheel 2), two modes of shock absorption are readily available. As previously mentioned and discussed above, a shock parallel to the central axis of wheel 2 can be absorbed by rotation of a sector or sectors 10 away from the shock around the interconnection rotational axes 17 intermediate adjacent sectors 10. The energy of this shock is, however, also absorbed via the beadlocking spacer 12A, 12B on the same side as the shock, as the shock while forcing the outer periphery of the sector 10 to rotate away from its normal position perpendicular to the central axis of the wheel 2, will force inclined surfaces 10A of said sector 10 outwardly from the central axis, forcing the adjacent and abutting portion of the said beadlocking spacer 12A, 12B outwardly from wheel rim 3. The beadlocking spacer 12A, 12B, being formed of elastic materials then acts in a spring-like fashion to resist this movement and force the sector 10 back into proper aligned position perpendicular to the central axis, absorbing the shock and restoring stasis. In addition, slide gaps 18A, 18B are provided between the inward part of sectors 10 and/or bottom spacer 13, and interfering features/ledges of rim 3, allowing displacement of the entire assembly comprised of sectors 10 inwardly or outwardly in response to such axial shocks (as indicated by arrows 19A, 19B).

In addition to the features previously described, a latching system can, as illustrated in FIGS. 7-10, be advantageously and simply added to our invention to further insure its assembled integrity and operational characteristics. To insure the rotational features of our invention remain intact, the latch system must make provision to allow continued rotation (as previously described) around rotational axis 17. This can be most expediently provided by the inclusion of a latching system featuring a cylindrical bolt 20 coaxial with axis 17. Bolt 20 is, in the figures provided, seated in a bolt sheath 21 inset into the lower connector part 11A. It is biased to extension via a spring 22 that is likewise seated in bolt sheath 21, and prevented from overextending via a bolt stop 23 inserted transverse to bolt 20 into bolt slot 20B after bolt 20 and spring 22 have been inserted into bolt sheath 21. Bolt 20 interfaces with a matching latch aperture 24 (formed using a steel bushing 24A) which is provided in upper connector part 11B, and which forms a cylindrical aperture that is, once again, coaxial with axis 17. Thus, the segments comprising the invention remain free to rotate around axis 17 in the manner previously described. Indeed, bolt 20 can be seen as supplementing this feature by acting as an axle around which such rotation takes place.

Bolt stop 23 also has a rotational cam surface 23A at its upper end by which it interacts with bolt slot 20B and thereby with bolt 20. Rotational cam surface 23A includes, as is typical and well known in the mechanical arts, a raised portion 23A′ in one quadrant that smoothly transitions via two side quadrants to a lower opposite quadrant 23A″. Thus, by rotation of bolt stop 23 using a screw driver in slot 23B′ provided in lower bolt end 23B, raised portion 23A′ and lower portion 23A″ can be rotated so as to reverse position, forcing bolt 20 back into bolt sheath 21 as indicated by arrows 30.

The tapered cam surface 20A of bolt 20 allows the lower connector part 11A and the upper connector part 11B to be slid together in the manner previously described for assembly of the invention, as it forces the bolt to withdraw into bolt sheath 21 in a manner well known in the mechanical arts related to door bolts when the two parts are joined. And, as described in the preceding paragraph, bolt 20 can be withdrawn from upper connector part 11B by using a screwdriver to rotate bolt stop 23, allowing the operation to be reversed so as to allow these parts to be separated.

Further, it should be noted that the positioning of the respective latch parts in the manner shown is not required as the bolt 20 and its related parts could be positioned within the upper connector part 11B, and the latch aperture 24 could be positioned within the lower connector part 11A. In this configuration, to allow the parts to slide together and fasten in the manner described, the tapered surface 20A should face downward rather than upward as illustrated in the drawing figures. However, in either configuration, the latching system described provides a positive locking feature for the invention and securely locks the segments together during assembly. It is especially useful at high speeds in maintaining system integrity and, once again, requires no specialized assembly tools and equipment that could interfere with repair and use by soldiers in the field.

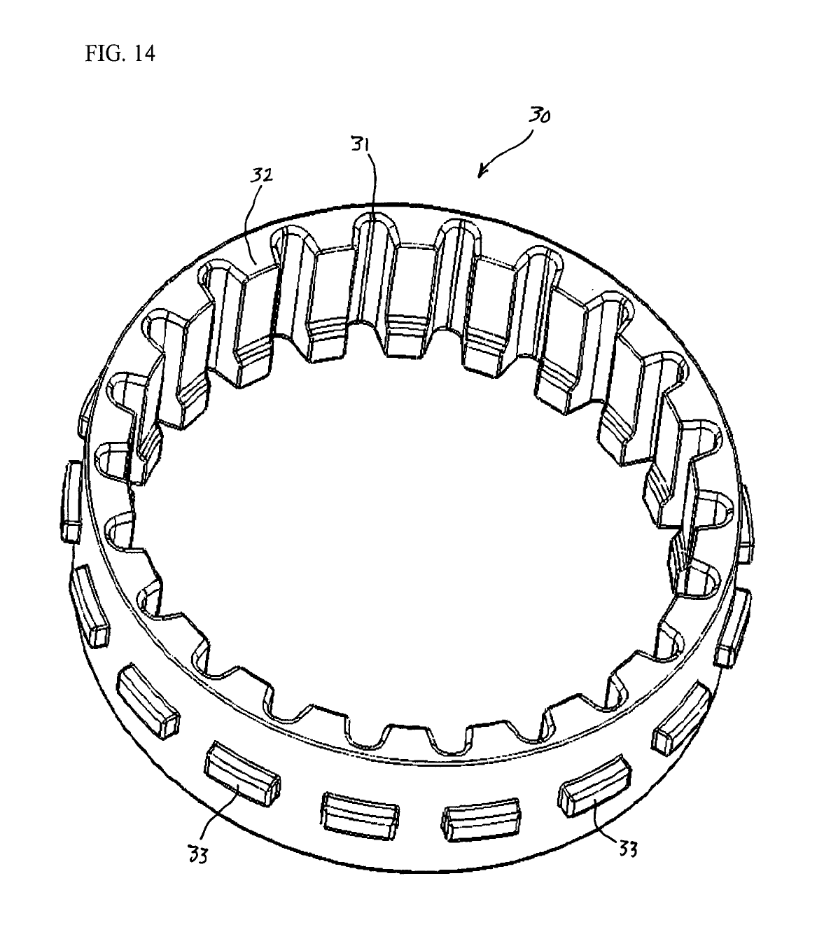

Having discussed many features common to both the more basic and the preferred embodiments of the invention, the distinctive features of the preferred embodiment are more easily highlighted. To begin with, in the preferred embodiment (as best seen in FIGS. 11, 13A, 13B, and 14), runner 30 replaces the spacers 13 of the basic embodiment as the rim abutting element. Runner 30 is preferably comprised of a durable, flexible plastic material well adapted to frictionally resist any sliding movement relative to rim 3, taking over the function of spacers 13 in this regard as well as in helping to resist and absorb axial shocks. As illustrated in FIG. 14, it is provided with bottom grooves 31 to assist it in bending for placement on a tire rim 3, creating bottom sections 32 that are also contoured so as to match the contour of rim 3 and allow the same type of lateral/axial sliding (in extreme circumstances) described in paragraph 41, above, with respect to the more basic embodiment.

In addition, runner 30 also replaces the lower portion of the sectors 10 adjacent rim 3 and abutted by firmly beadlocking spacers 12A, 12B, taking over the role played by this portion of sectors 10 in the embodiment described in FIGS. 1-10. This is necessary due to the primary new innovation introduced in the preferred embodiment, i.e., the ability of sectors 10 in this embodiment to slide along with/rotate with tire 5 and/or in relation to rim 3. A stationary portion of the runflat system is necessary adjacent and abutting rim 3 in order to support and maintain stationary non-sliding beadlocking spacers 12A, 12B in position. The bottom portion of spacers 10 in the basic embodiment played this role, but in order to allow sectors 10 to slide/rotate in the manner described, it is necessary to replace them in this role. In the preferred embodiment this role is, therefore, played by an expanded stationary rim abutting element, runner 30.

The reason it is important for sectors 10 to slide/rotate in the manner described is related to the function this innovation serves in eliminating friction between sectors 10 and tire 5. Generally, friction and frictional heating generated by contact between the portions of runflat devices extending transversely to the axis of rim 3 (which serve to support a tire 5 when it is flat) and the tire itself are a leading cause of runflat/tire failure. This friction is generated by the fact that, e.g., the inner surface 5A of tire 5 has a greater circumference than that of sectors 10. This means that where the inner surface 5A is pressed against sectors 10 in a runflat situation, it slides relative to sectors 10, generating immense amounts of friction and frictional heating. This frictional heating is a major cause of runflat failure and tire failure when operating in a runflat condition. Consequently, in order to minimize this, it is necessary to minimize tire 5 slide and/or the effects of tire 5 slide relative to sectors 10.

In the preferred embodiment, this is accomplished by the positioning of a low friction member 40 intermediate sectors 10 and rim 3 on runner 30. In the preferred embodiment illustrated, low friction member 40 takes the form of a planar sheet of materials provided with perforations allowing it to be fitted to runner 30 over extensions 33. It can be further stabilized in position on runner 30 via screwing it to runner 30 with screws placed intermediate extensions 33 or via adhesion, or using other means known to those skilled in the art. Extensions 33 also serve as centering guides for sectors 10, fitting into an extension slot 50 provided in the bottom of the sectors 10 of the preferred embodiment, and assisting in holding said sectors 10 in their preferred and necessary operating position (as illustrated in FIG. 11). The aforesaid innovations allow sectors 10 to freely slide in relation to runner 30, allowing them to rotate freely around rim 3, and rotate to rotate freely with tire 5 when frictionally engaged therewith in a runflat condition. This, in turn, greatly reduces and/or completely eliminates the frictional heating problems previously described.

In addition, assembly of the preferred embodiment (like the more basic embodiment) remains simple. First, referring generally to FIGS. 11 and 14, and as previously described with respect to the more basic embodiment, sectors 10 are interconnected within the tire 5 by hand with no tools being necessary or even helpful for this purpose. Second, runner 30 (with low friction member 40 attached) is inserted into position inside sectors 10 with extensions 33 positioned in slots 50. Third, beadlocking spacers 12A, 12B are positioned intermediate runner 30 and beads 5A, 5B. Fourth, the inner section 3B is then inserted through the open center of tire 5 and assembled to outer section 3A of rim 3, securing the various components mentioned in operative position.

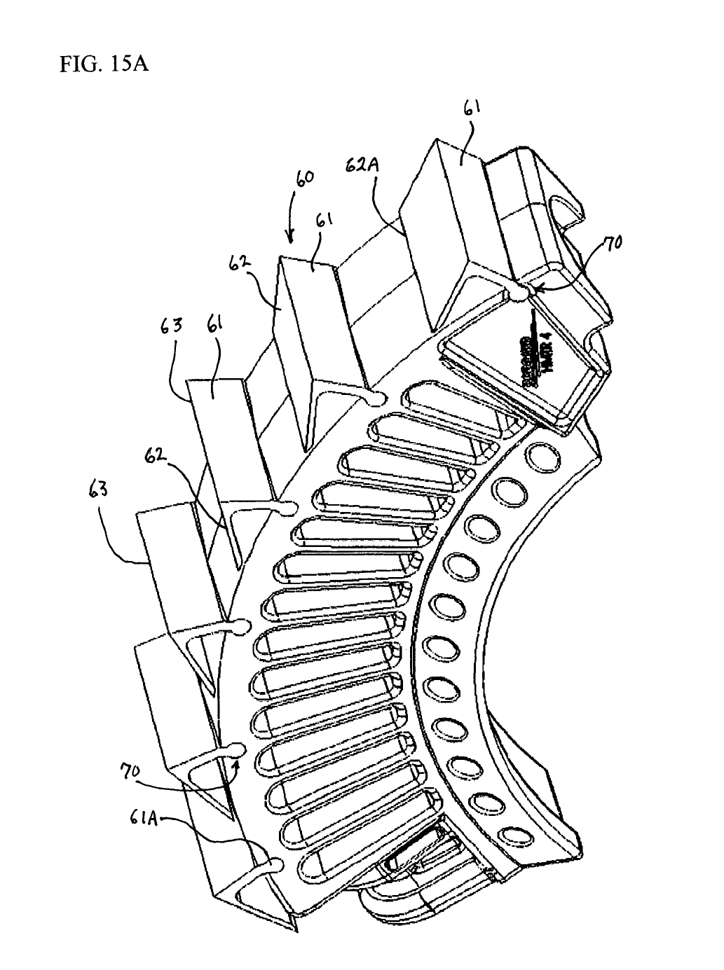

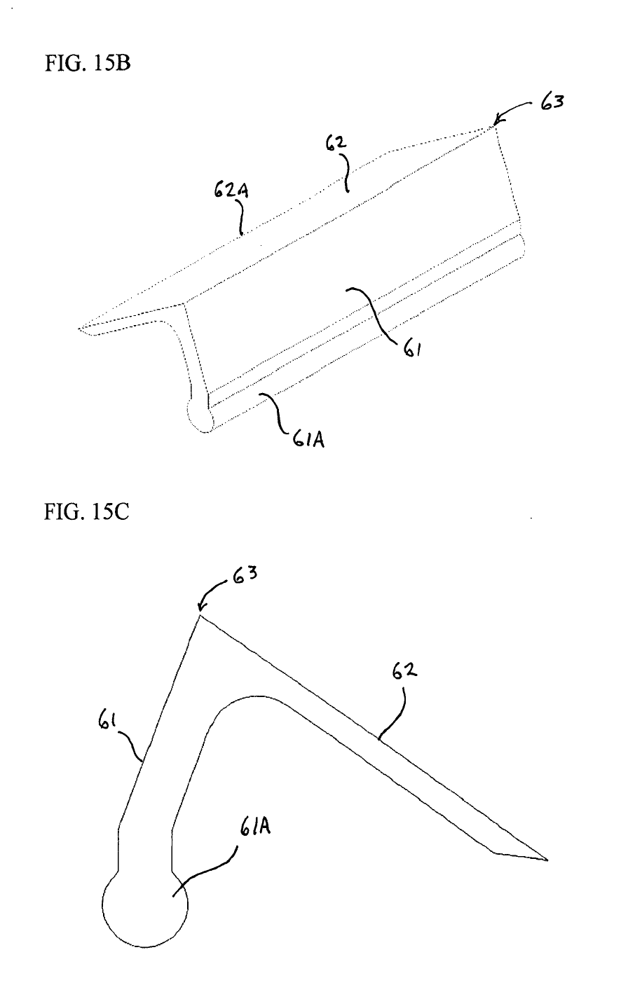

Finally, and in addition to the aforesaid friction reducing innovations, our invention can also include circumferential compensators 60 mounted to the circumference of sectors 10 intermediate sectors 10 and tire 5. (See, e.g., FIGS. 15A-15C). Compensators 60 preferably take the form of resilient deformable (i.e., compressible) L-shaped members, with said shape defining two legs 61, 62 with ends 61A, 62A, and an apex 63 positioned away from sector 10 towards the inner surface of tire 5. End 61A of leg 61 is attached to the circumference of a sector 10, while end 62A of the other leg 62 is slidable along the circumference of sector 10 as compensator 60 is compressed (i.e., squeezed flat) between tire 5 and the sector 10. As illustrated in FIG. 15A, end 61A can advantageously be attached to the circumference of a sector 10 by molding end 61A as a cylindrical member (as illustrated in FIGS. 15A-15C) and providing a cylindrical slot 70 with a cylindrical cross-section that end 61A can be slid into (and thereby be maintained in stable position on and in relation to the circumference of sector 10). In the form and geometry illustrated, the distance between slots 70 should be at least equal to the added lengths of legs 61 and 62, so as to allow the complete compression of compensator 60. Thus, the number of compensators 60 will necessarily depend to some extent on their size. This, in turn, can be based on the degree of slide of tire 5 relative to sectors 10, as further discussed below, deemed advantageous in a particular application.

To envision the operation of compensators 60, consider that they are mounted with their sliding end 62A directed in the direction of circumferential motion of tire 5 and sectors 10 when in normal forward motion. Thus, as sectors 10 with compensators 60 roll underneath the vehicle and are compressed between the inner surface of tire 5 and the outer circumference of a sector 10, apex 63 initially contacts the inner surface of tire 5 and then, due in part to its pointed wedge shape, adheres to the inner surface of tire 5 (due to mechanical forces) in more-or-less the same position at which it contacts the inner surface of tire 5, minimizing sliding vis-à-vis the compensator 60. Then, as compensator 60 is further compressed, apex 63 travels with the inner surface of tire 6, pivoting over from its initial position (with first end 61A acting as a pivot point) until it is flat against sector 10. In doing this, compensator 60, via the use of apex 63 as a pivoting contact with the inner surface of tire 5, allows tire 5 inches of circumferential slide relative to the outer circumference of sector(s) 10, as well as acting as a shield between (and minimizing contact between) sectors 10 and the inner surface of tire 10. Then, once the said compensator 60 (by further rotation of its sector 10 out from the under the vehicle) is no longer compressed between tire 5 and compensator 10, it is free to resume its initial configuration.

The amount of slide will, in fact, be approximately equal to the length of leg 61 in the preferred configuration illustrated and discussed herein. However, while the geometry and form specified is considered advantageous, it should be remembered that the invention can take other forms. Its most important aspect is the provision of a member (in this case leg 61) that is connected to and extends transversely to sector 10, which member will contact and adhere to the inner surface of a tire 5 at its other end (in this case apex 63) and which end will thereafter rotate, pivot or otherwise move along with tire 5 in the direction of circumferential motion of the tire 5 and sector 10, so that it lays down flat therebetween as it is compressed and after being so compressed, resumes its former position.

Finally, the materials utilized in forming sectors 10 are extremely important. In this regard, the materials chosen should ideally offer superior compression loading strength with overload capabilities if required by tactical situations. In addition, they should safeguard vehicle occupants by absorbing curb shock energy. This can best be accomplished by utilizing a material formulated to provide deceleration of energy that traditionally was conducted through stiffer materials (such as metallic materials), or rebounded with less stiff materials (such as rubber). Energy absorption is the best solution to maintain vehicle control and reduce operator injury. Further, the material should be compliant to varying load conditions and keep the tire tread firmly secured to the road surface for maximum vehicle control and traction. It should also reduce vehicle weight over existing runflat designs and be operable at extreme temperatures. Ideally, it should also be ballistic resistant and maintain ballistic resistance down to −40 degrees F.

However, numerous variations in terms of material as well as in regard to other features of the invention are possible without deviating from and/or exceeding the spirit and scope of the invention. In addition, various features and functions disclosed above, or alternatives thereof, may be desirably combined into many other different systems or applications. Further, various presently unforeseen or unanticipated alternatives, modifications, variations or improvements therein may be subsequently made by those skilled in the art which are also intended to be encompassed by the claims that follow.

What is claimed is:

1. A runflat system for use with a tubeless tire mounted on a wheel rim of a motor vehicle, the wheel rim having a wheel rim axis and including a plurality of pieces and the tire including beads mounted against flanges of said rim, the system comprising:
a plurality of arcuate sectors, each of said sectors being linked to at least one other sector such that said plurality of sectors form an at least substantially continuous ring around said wheel within said tire; and
wherein said plurality of sectors are provided with connector parts at ends thereof by which they are so linked and said connector parts at least one of
are formed as molded portions of said sectors, such that each sector and its respective connector parts form a single one-piece molded part,
include interconnecting male and female junctions, with each sector having a male part at one end and a female part at an opposite end such that said sectors can be connected end-to-end via said junctions,
are formed as interconnecting male and female junctions, with said male and female junctions being arranged for linkage via movement in a direction perpendicular to the wheel rim axis,
are formed so as to allow rotation around an interconnection rotational axis, such that each sector can be rotated around said interconnection rotation axis with respect to an adjacent sector,
include interconnecting concave and convex arcuate support members, with each sector having a convex member at one end and a concave member at an opposite end such that said sectors can be connected end-to-end via said members,
include interconnecting concave and convex arcuate support members, said support members when connected forming a bearing surface so as to allow rotation around an interconnection rotational axis, such that each sector can be rotated around said interconnection rotation axis with respect to an adjacent sector, and
include a releasable latching system for connecting the sectors, which latching system allows rotation around an interconnection rotational axis, such that each sector can be rotated around said interconnection rotation axis with respect to an adjacent sector.

2. The runflat system described in claim 1, said system further comprising at least one of
beadlock spacers forming rings around said wheel intermediate the beads of said tire and said plurality of sectors, said beadlock spacers thereby inhibiting movement of said plurality of sectors parallel to said rim axis and holding said plurality of sectors in optimum operating position on said wheel rim between said beads,
a bottom spacer forming a ring around said wheel between said wheel and said plurality of sectors, said bottom spacer serving to inhibit sliding movement of said plurality of sectors around said wheel rim and holding said plurality of sectors in spaced relationship to said rim, and
friction reduction apparatus for reducing friction between said sectors and the tire when the tire is in a runflat condition.

3. The runflat system described in claim 2, wherein said friction reduction apparatus is positioned one of intermediate said sectors and said rim and intermediate said sectors and said tire.

4. The runflat system described in claim 2, wherein said friction reduction apparatus allows said sectors to one of rotate freely around said rim, and rotate freely with said tire.

5. The runflat system described in claim 2, wherein said friction reduction apparatus is one of
positioned intermediate said sectors and said rim and includes a low friction member formed from material having a low coefficient of friction positioned adjacent said sectors and intermediate said sectors and said rim such that said sectors are slidable on said low friction member, and
positioned intermediate said sectors and said tire and includes compensators attached to the circumference of said sectors, which compensators minimize circumferential sliding of said tire against and relative to said sectors.

6. The runflat system described in claim 5, wherein said compensators include a member connected to the sector at one end and having another end extending from the sector towards the tire, which other end will contact and rotate with the tire when the member is compressed between the sector and the tire so as to become flattened against the sector and between the sector and the tire when operating in a runflat condition.

7. The runflat system described in claim 5, wherein said low friction member is mounted to a non-sliding portion of said runflat system, which non-sliding portion is proximate to and rotatable with said rim.

8. A runflat system for use with a tubeless tire mounted on a wheel rim of a motor vehicle, the wheel rim having a wheel rim axis and including a plurality of pieces and the tire including beads mounted against flanges of said rim, the system comprising:
a plurality of arcuate sectors, each of said sectors being linked to at least one other sector such that said plurality of sectors form an at least substantially continuous ring around said wheel within said tire; and
friction reduction apparatus for reducing friction between said sectors and the tire when the tire is in a runflat condition.

9. The runflat system described in claim 8, wherein said friction reduction apparatus is positioned one of intermediate said sectors and said rim and intermediate said sectors and said tire.

10. The runflat system described in claim 8, wherein said friction reduction apparatus allows said sectors to one of rotate freely around said rim, and rotate freely with said tire.

11. The runflat system described in claim 8, wherein said friction reduction apparatus is one of
positioned intermediate said sectors and said rim and includes a low friction member formed from material having a low coefficient of friction positioned adjacent said sectors and intermediate said sectors and said rim such that said sectors are slidable on said low friction member, and
positioned intermediate said sectors and said tire and includes compensators attached to the circumference of said sectors, which compensators minimize circumferential sliding of said tire against and relative to said sectors.

12. The runflat system described in claim 11, wherein said compensators include a member connected to the sector at one end and having another end extending from the sector towards the tire, which other end will contact and rotate with the tire when the member is compressed between the sector and the tire so as to become flattened against the sector and between the sector and the tire when operating in a runflat condition.

13. The runflat system described in claim 11, wherein said low friction member is mounted to a non-sliding portion of said runflat system, which non-sliding portion is proximate to and rotatable with said rim.

14. The runflat system described in claim 8, wherein said plurality of sectors are provided with connector parts at ends thereof by which they are so linked and said connector parts at least one of
are formed as molded portions of said sectors, such that each sector and its respective connector parts form a single one-piece molded part,
include interconnecting male and female junctions, with each sector having a male part at one end and a female part at an opposite end such that said sectors can be connected end-to-end via said junctions,
are formed as interconnecting male and female junctions, with said male and female junctions being arranged for linkage via movement in a direction perpendicular to the wheel rim axis,
are formed so as to allow rotation around an interconnection rotational axis, such that each sector can be rotated around said interconnection rotation axis with respect to an adjacent sector,
include interconnecting concave and convex arcuate support members, with each sector having a convex member at one end and a concave member at an opposite end such that said sectors can be connected end-to-end via said members,
include interconnecting concave and convex arcuate support members, said support members when connected forming a bearing surface so as to allow rotation around an interconnection rotational axis, such that each sector can be rotated around said interconnection rotation axis with respect to an adjacent sector, and
include a releasable latching system for connecting the sectors, which latching system allows rotation around an interconnection rotational axis, such that each sector can be rotated around said interconnection rotation axis with respect to an adjacent sector.

15. The runflat system described in claim 8, said system further comprising at least one of
beadlock spacers forming rings around said wheel intermediate the beads of said tire and said plurality of sectors, said beadlock spacers thereby inhibiting movement of said plurality of sectors parallel to said rim axis and holding said plurality of sectors in optimum operating position on said wheel rim between said beads,
a bottom spacer forming a ring around said wheel between said wheel and said plurality of sectors, said bottom spacer serving to inhibit sliding movement of said plurality of sectors around said wheel rim and holding said plurality of sectors in spaced relationship to said rim.

16. The runflat system described in claim 6, wherein said compensators are compressible L-shaped members, said shape defining an apex and two legs with ends, an end of one leg of said L-shaped member being attached to the circumference of a sector and an end of the other leg of said L-shaped member being slidable along said circumference as the member is compressed between the tire and the sector.

17. The runflat system described in claim 12, wherein said compensators are compressible L-shaped members, said shape defining an apex and two legs with ends, an end of one leg of said L-shaped member being attached to the circumference of a sector and an end of the other leg of said L-shaped member being slidable along said circumference as the member is compressed between the tire and the sector.

18. A runflat system for use with a tubeless tire mounted on a wheel rim of a motor vehicle, the wheel rim having a wheel rim axis and including a plurality of pieces and the tire including beads mounted against flanges of said rim, the system comprising:
a substantially continuous runflat ring around said wheel within said tire; and
friction reduction apparatus for reducing friction between said runflat ring and the tire when the tire is in a runflat condition, said friction reduction apparatus at least one of
being positioned one of intermediate said runflat ring and said rim and intermediate said runflat ring and said tire,
allowing said runflat ring to one of rotate freely around said rim, and rotate freely with said tire,
positioned intermediate said runflat ring and said rim and includes a low friction member formed from material having a low coefficient of friction positioned adjacent said runflat ring and intermediate said runflat ring and said rim such that said runflat ring is slidable on said low friction member, and
positioned intermediate said runflat ring and said tire and includes compensators attached to an outer circumference of said runflat ring, which compensators minimize circumferential sliding of said tire against and relative to said runflat ring.

19. The runflat system described in claim 18, wherein at least one of
said compensators include a member connected to the runflat ring at one end and having another end extending from the runflat ring towards the tire, which other end will contact and rotate with the tire when the member is compressed between the runflat ring and the tire so as to become flattened against the runflat ring and between the runflat ring and the tire when operating in a runflat condition, and
said low friction member is mounted to a non-sliding portion of said runflat system, which non-sliding portion is proximate to and rotatable with said rim.

20. The runflat system described in claim 18, wherein said compensators are compressible L-shaped members, said shape defining an apex and two legs with ends, an end of one leg of said L-shaped member being attached to the circumference of the runflat ring and an end of the other leg of said L-shaped member being slidable along said circumference as the member is compressed between the tire and the runflat ring.
